(19) United States
(12) Patent Application Publication
(10) Pub. No.: US 2001/0037964 A1
(43) Pub. Date: Nov. 8, 2001

(54) FILTER SYSTEM

(75) Inventors: JAY WON, MARKHAM (CA); ANDRE TREMBLAY, GLOUCESTER (CA); HENRY HUNSE, GUELPH (CA)

Correspondence Address: R. CRAIG ARMSTRONG, ARMSTRONG & ASSOCIATES, 285 FOUNTAIN STREET SOUTH, CAMBRIDGE, N3H1J2, CA

(73) Assignee: WON JAY

(21) Appl. No.: 09/275,089

(22) Filed: Mar. 24, 1999

Related U.S. Application Data
(60) Provisional application No. 60/079,325, filed on Mar. 25, 1998.

(51) Int. Cl. B01D 63/02

(52) U.S. Cl. 210/120; 210/321.89; 210/314; 210/335

(57) ABSTRACT

The filter has hollow fiber membranes which are spaced apart from each other and are held in a substantially linear fashion between a first bonded layer and second bonded layer. This allows the membranes to work effectively without having to be looped. This placement also avoids the kinking of the membranes and stretching in the membrane which in turn would undesirably increase the pore size. The filter thus has a plurality of porous membranes, each membrane having a hollow passage therein and having a first end and second end, and each end having an opening. The first bonded layer is affixed to the first ends so as to block fluid entry through the openings of the first ends. The second bonded layer is affixed to the second ends so as to leave the openings of the second ends exposed for fluid exit from the hollow fiber membranes.

### REFERENCE TO RELATED APPLICATION

This is a formal application based on and claiming the benefit of the filing date of a provisional application filed on Mar. 25, 1998, Ser. No. 60/079,325.

### BACKGROUND OF THE INVENTION

1. Field of the Invention

This invention relates to water filter systems.

2. Description of the Prior Art

In traditional hollow fiber membrane water filter systems, the hollow fiber membrane is looped in a U-shape prior to embedding the ends into the bonding material (as illustrated in FIG. 2). Next, a cut is made through the bonding material and the embedded hollow fiber membranes to expose the hollow interior of the membrane fiber and allow water to pour through. The filter module, however, has functional drawbacks.

One of the drawbacks is that the membrane loop causes fibers to touch each other thereby restricting flow of the fluid. In addition, looping causes kinking of the membranes and stretching of the pore size. Pore size is an important element of the effectiveness of any water filter.

It is desired to have an automated manufacturing process that produces a filter module that does not have the functional drawbacks of the current looped filters.

### SUMMARY OF THE INVENTION

It is an object of the invention to overcome some of the drawbacks of traditional hollow fiber membrane filter systems.

It is another object of the invention is to be more amenable to manufacturing automation, thereby lowering manufacturing costs.

In the invention, there is provided a unique placement of the hollow fiber membranes. The hollow fiber membranes are spaced apart from each other and are held in a substantially linear fashion between a first bonded layer and second bonded layer. This unique placement of the membranes allows the membranes to work effectively without being looped. This placement also avoids the kinking of the membranes and stretching in the membrane which in turn would undesirably increase the pore size.

Therefore, there is provided in the invention, a filter system for fluids comprising: a plurality of porous membranes, each membrane having a hollow passage therein and having a first and second end, and each end having an opening; a first bonded layer adapted to said first ends so as to block fluid entry through said openings of said first ends; and, a second bonded layer adapted to said second ends so as to leave said openings of said second ends exposed for fluid exit.

Further features of the invention will be described or will become apparent in the course of the following detailed description.

### BRIEF DESCRIPTION OF THE DRAWINGS

In order that the invention may be more clearly understood, a preferred embodiment thereof will now be described in detail by way of example, with reference to the accompanying drawings, in which:

FIG. 1 is a schematic of a water filter system according to the invention;

FIGS. 1A and 1B shows a flow chart of the process for making filter modules according to the invention;

FIG. 2 is a perspective view of a water filter according to prior art;

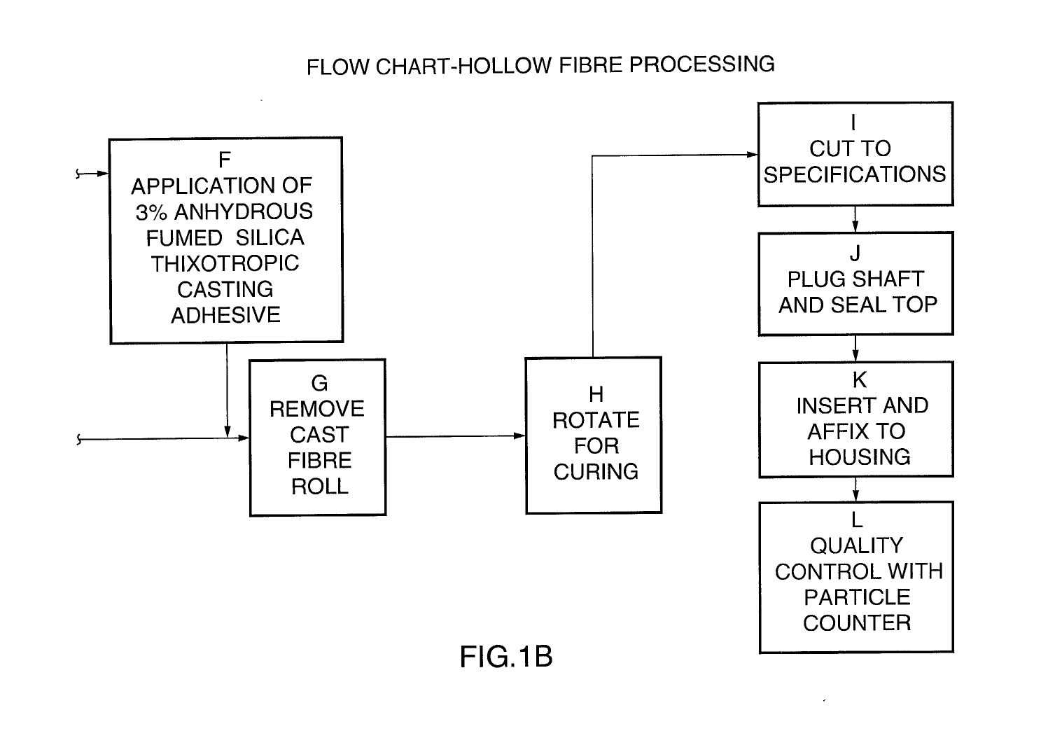

FIG. 3 is a partial sectional view of a hollow fiber illustrating the flow of a fluid through the membrane walls of the fiber;

FIG. 4 is a cross-sectional elevational view of the hollow fiber membrane; and,

FIG. 5 is a schematic of the process of manufacturing filter modules according to the invention;

FIG. 6 is a schematic of a traversing adhesive dispenser bank according to the invention; and,

FIG. 7 is a view of a filter module and housing.

### DETAILED DESCRIPTION OF THE PREFERRED EMBODIMENT

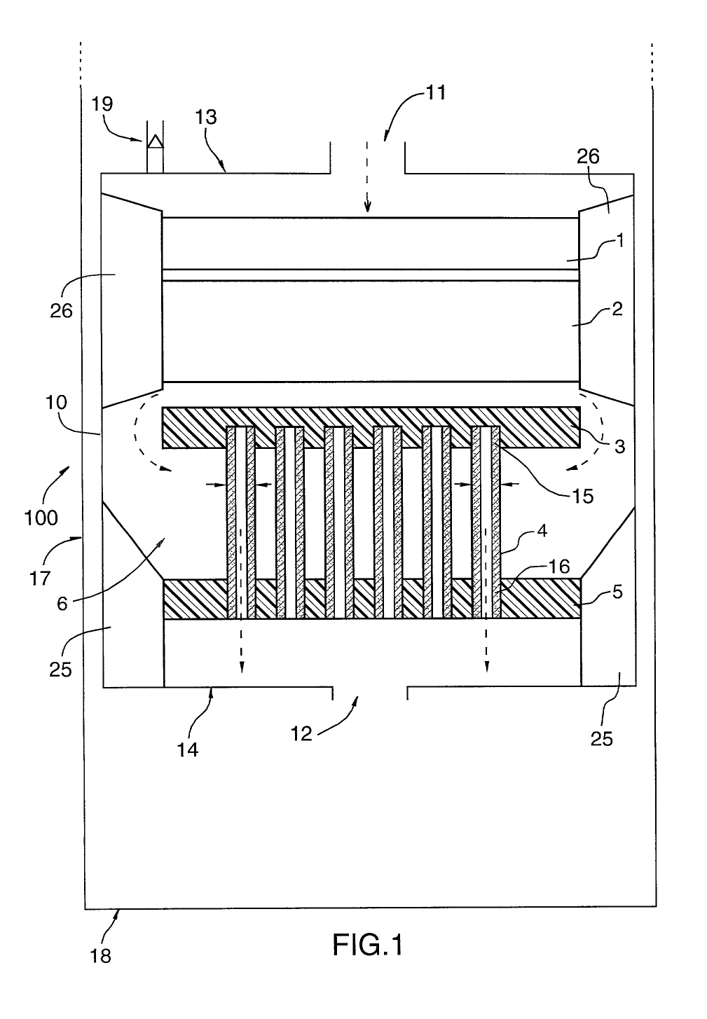

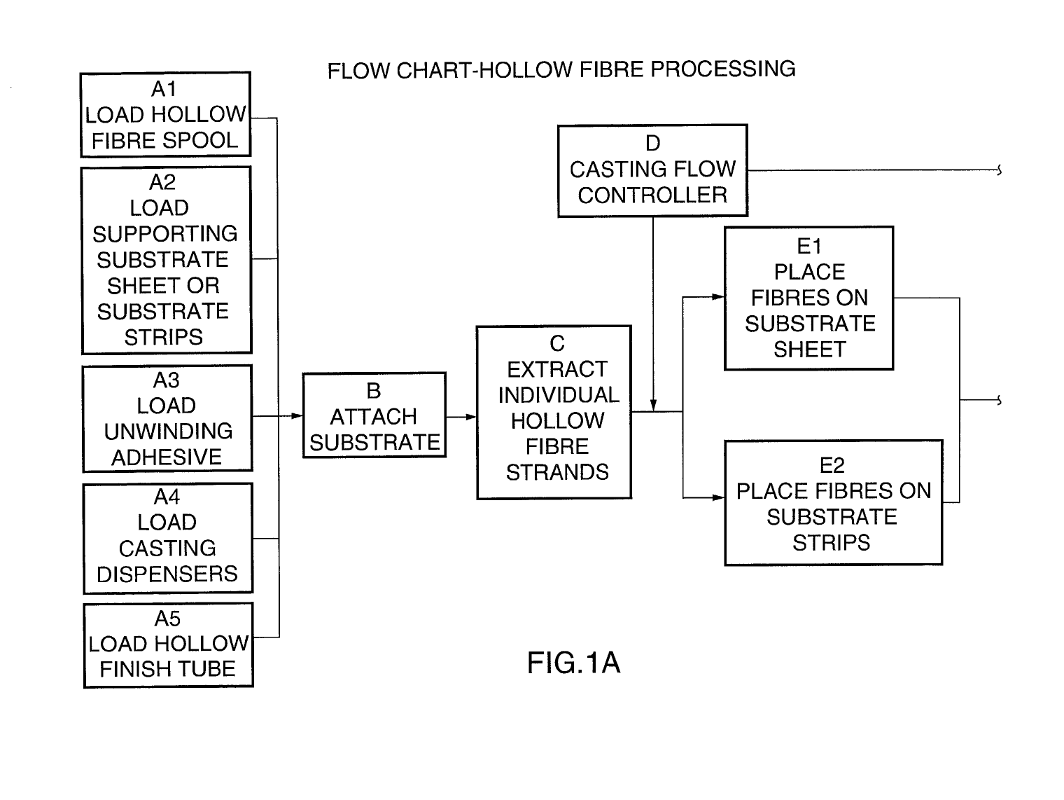

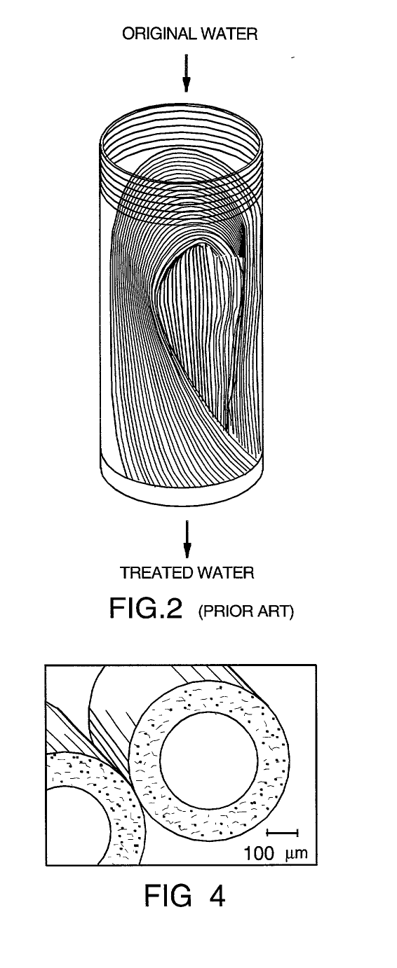

A preferred embodiment of the invention is shown in FIG. 1. The invention particularly relates to the filtration of water. The description that follows describes the invention in conjunction with water, but the invention is effective with other fluids as well. As shown in FIG. 1, the invention relates to the placement of the hollow fiber membranes 4. The hollow fiber membrane 4 is similar to a porous pipe (as shown in FIG. 3). The water (the direction of which is illustrated by dotted arrows in FIG. 1) is filtered by the hollow fiber membranes 4 by the fluid crossing the wall from the outside to the hollow inside. It then flows down the inside of the fiber to the open end having the lowest pressure. The pore size of the hollow fiber membrane 4 in question is preferably 0.04 to 0.001 microns in size. In the water filtration application, a pore size of 0.04 microns can advantageously effectively block disease causing organisms such as cryptosporidium, giardia lambia, all bacteria, certain viruses, and many protein clusters. Because of the nature of the hollow fiber membrane, little pressure is required to have the water pass through. Hollow fiber membrane technology is currently used in the fields of kidney dialysis, oil processing, water treatment, and others. The pore size may vary depending on the application.

A disposable water filter system 100 according to the invention comprises a sealed housing 10 having a water inlet 11, positioned at a top end 13 of the housing, and a water outlet 12, positioned at a bottom end 14 of the housing. The housing defines a cavity region which houses a first filter element 1 and a second filter element 6. The second filter element is arranged in series with the first filter element. The first filter element 1 advantageously comprises a carbon bed filter. The second filter element comprises a plurality of hollow fibers 4, each fiber constituting a hollow membrane. The hollow fibers are positioned in a substantially linear and parallel fashion relative to one another. The membrane walls are microporous, thus letting smaller particles such as water molecules pass through the membrane but blocking other larger particles. The membrane walls define a hollow passageway for filtered water to flow through. The disposable water filter system further comprises a first layer 3 of cast material bonded to first ends 15 of the hollow fibers 4, so as to block fluid entry through the openings of the hollow fibers at the first ends, and a second layer 5 of cast material bonded to second ends 16 of the hollow fibers so as to expose the openings of the hollow fibers at the second ends to enable filtered water to exit. The first layer 3 and the second layer 5 are co-axially spaced apart so as to be relatively parallel and linear to one another.

According to yet another preferred embodiment of the invention, a third filter element 2 is arranged in series with and between the first filter element 1 and the second filter element 6. This third filter element may be any traditional type of filter element.

The housing 10 further comprises a first sealing means 25, which is arranged to create a fluid seal around the perimeter of the second layer 5 so that a fluid may only exit the second filter element 6 through the hollow fibers 4. Further, a second sealing means 26 is arranged to restrict fluid to flow only through the filtering portions of the first filter element 1 and the third filter element 2. Preferably, the housing 10 includes a one-way air valve 19 to allow air to escape from inside the housing and outwards. The one-way air valve is utilized to allow the air to escape from the bottom of the filter, to prevent air lock and flow restriction caused by the air lock.

According to one preferred embodiment of the invention, the second filter element 6 is disposed upstream from the first filter element 1.

According to another preferred embodiment of the invention, the second filter element 6 is disposed downstream from the first filter element 1.

The membrane walls of the hollow fibers 4 advantageously have pore sizes in the range of 0.001 through to 0.04 micro-meters (microns) and thereby block at least cryptosporidium, giardia, bacteria, sediment and organic products, whilst letting water molecules pass through the membrane walls, which is shown in FIG. 3.

The filter system 100 further advantageously includes a water vessel 17 having a base 18 to releaseably receive the filter housing 10 in the water vessel. The water vessel is large enough to hold the required amount of filtered water. In FIG. 1, the water vessel 18 is shown for illustration only and the shape and size of the vessel may be varied according to the desired application.

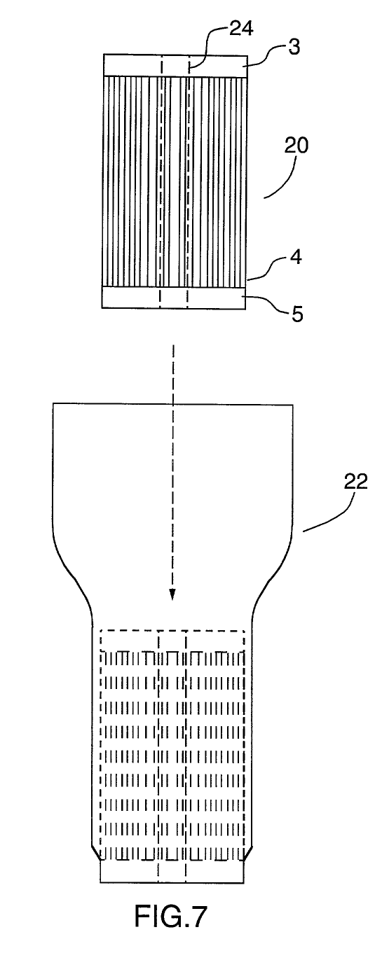

With reference to FIG. 7, the hollow fiber module, generally designated with reference numeral 20, of the filtration series will now be described. The module preferably has a bundle of between 10 and 10,000 (or more) of the hollow fiber membranes having a length required for adequate flow rate and filtration. As will be described in more detail below, there may be up to 10 casting compound lines spread over a half meter length of fiber bundle rolled around the mandrel. When the casting compound is hard, the mandrel having 10 evenly spaced disks approximately 1 cm thick by 2 inches in diameter and 1000 fibers traversing each disk. The disks are then cut perpendicular to the axis of the mandrel leaving small cylinders, known herein as modules, having open fibers on both ends. At this point one end of the module, this end referred to as the first 3 bonded layer, is embedded in a bonding material which could be epoxy or polyurethane glue or 3% anhydrous fume silica thixotropic adhesive compound (all bonding materials hereinafter referred generally to as casting compound). The casting compound is then allowed to harden. The second bonded layer 5 remains exposed with open ends of the fibers as so to allow the filtered water to flow through it (as shown in FIG. 1). The first 3 and second 5 layers are sufficiently spaced apart by a center mandrel 24 to ensure the hollow fiber membranes 4 do not kink. The hollow fiber membranes are preferably substantially linear, but nonetheless the fibers may slightly sag somewhat.

The completed module can be inserted in an existing filter, or installed by other means in a filtration system. The completed module in a preferred embodiment of the invention is inserted into a module housing 22 (as shown in FIG. 7). Preferably, a series of pre-filters 1, 2, for example carbon bed filters, are used to remove sediment, off-odors, taste, lead, and resin to soften the water. Consequently, the water will pass through this series of pre-filters before being filtered by the module. The water will then flow through the hollow fiber membrane 4, with a pore size of 0.04 micron to 0.001 micron, blocks cryptosporidium, giardia, bacteria, sediment, organic products, and some viruses from passing through. The filtered water can be consumed directly, or can be treated with other processes such as reverse osmosis.

The filter system can function in both pressurized and gravity flow applications.

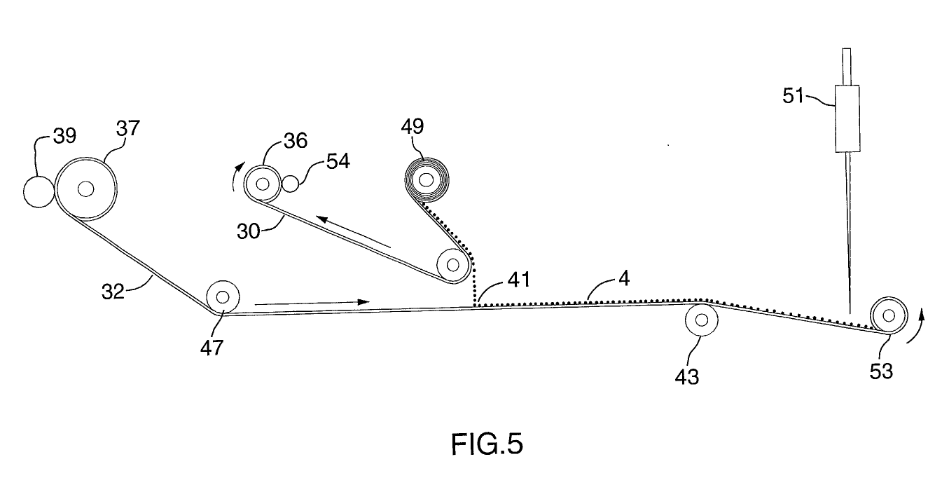

The manufacturing process will now be described. The membrane fibers are received, from the manufacturer, in small bundles, generally 0.5 m long, held at one end by a small tie-wrap. When received in this state, some pre-processing is required before the actually manufacturing process begins. The pre-processing includes the first step of transferring the fibers to a more usable format. The fibers are transferred onto an adhesive tape by successively contacting the top of the bundle with a fresh section of tape. Eventually, one end of every fiber is stuck onto the tape. A typical bundle of 1000 fibers is distributed over 0.6 m to 1.5 m of tape. The second step is to transfer the taped fibers now freely dangling from the taped end to an easily dispensable format. This is achieved by winding the taped fibers around a vertical spool along with a light fabric or mesh or webbing (hereinafter referred to as the first substrate surface 30). The fibers are oriented so as to ensure that they are disposed in a parallel fashion to axis of the spool. The strands of hollow fibers are, therefore, supported by the first substrate surface. The first substrate surface may be either in the form of a continuous sheet or a plurality of strips (the latter being illustrated). Once several meters of combination of fibers, tape and first substrate surface is wound, the wound spool 49 is mounted horizontally onto the manufacturing bench as shown in FIG. 5. The preprocessing steps may not be required if the manufacturer of the fibers provides the same in the desired mountable and dispensable format described above.

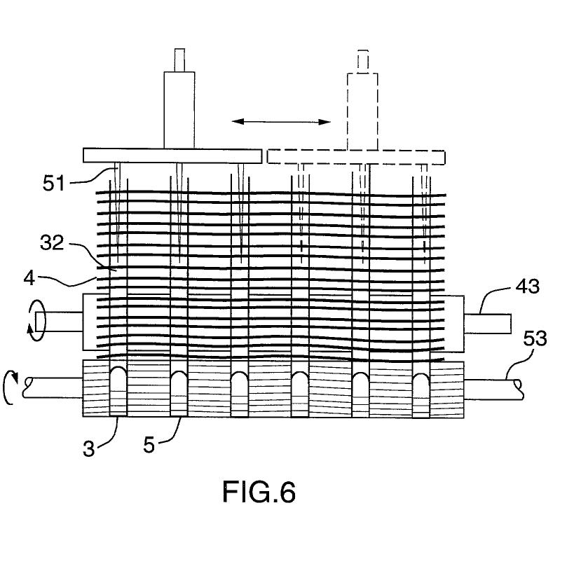

As shown in FIG. 5, the main components of the manufacturing apparatus include a first spool 49 having individual strands of hollow fibers 4 disposed in a parallel fashion to the axis of the spool; a take up spool 36 having a first substrate surface 30 taken up about its axis; a bank of adhesive dispensers, generally designated as 51, and a mandrel 53 for take-up of both fibers and second substrate surface 32 for the wound filter module. The pneumatically controlled adhesive dispensers 51 are positioned according to required specifications. In one embodiment, the dispensers may be positioned directly above the mandrel at a distance of about 1 cm above the preferred final diameter of the roll. The dispensers preferably dispense a 3% anhydrous fumed silica thixotropic adhesive compound. Other adhesive compounds would also work effectively. Although only one individual strand hollow fiber spool is shown in FIG. 5, it is anticipated that a plurality of these spools may be fed in parallel as shown in FIG. 6, thus increasing the efficiency of the manufacturing process. In addition, a single bank of dispensers may be adapted onto a conveying arm to traverse the length of a plurality of hollow fiber spools.

To start the manufacturing process, the leader end of the first substrate surface is fed through the feed path, either manually or automatically, and is attached to the take up spool 36. Second substrate surface 32 is supplied, tensioned, and the linear amount of fibers dispensed is measured by a digital counter 39. The linear velocity of the second substrate surface is also determined by the digital counter. The digital counter in one embodiment is a counter with a small wheel attached thereto and biased to touch the outside layer of a dispensing roll 37. The second substrate is attached to the mandrel 53 by preferably a hot melt casting compound.

The overall manufacturing process is controlled by a programmed computer. The basic sequence the computer controls is: (1) air pressure is applied to the adhesive dispensers and casting compound starts flowing therefrom and onto the mandrel, (2) a first substrate surface 30 is taken up by the take up spool 36 at a predetermined rate and fibers are dispensed onto the second substrate surface 32 at a distribution point 41. At the same moment the computer winds the second substrate and the fibers at a predetermined speed by the digital counter. The process continues until the desired length of first or second substrate surface is dispensed. A desired length will produce a desired diameter of the filter module. The feed path of the hollow is illustrated in FIG. 5. The primary end product is a hollow filter module 20, as shown in FIG. 7. As shown in FIG. 5, the manufacturing process utilizes two substrate surfaces. The first substrate surface 30 is light and used to gently wrap the fibers. The substrate surface material must be carefully selected as to limit electrostatic interactions between itself and the fibers. Its purpose is to stop the entanglement of fibers and to deliver them to the second substrate surface 32 for eventual winding on mandrel 53. The second substrate surface is used to wrap the fiber onto the mandrel and eventually stays in the module.

The amount of fibers contained in the module is controlled by the take-up speed of the take up roll 36. The speed can be controlled by a counter and motor. Alternatively, a belt may be connected to the dispensing roll 37.

First substrate surface 30 is operated at low tension to minimize shear forces on the fiber. Second substrate surface 32 is operated at a higher tension needed to keep the fibers tightly wound onto the mandrel and to squeeze the casting compound through the successive layers of fiber being rolled onto the mandrel. A single substrate process has been found to be problematic in that when tensioning levels are raised to the level found in the dispensing roll 37 the fibers trapped between two layers of webbing are subjected to shear forces which causes them to collapse and break. The dual substrate web approach disclosed herein permits gentle dispensing of the fibers while at the same time allow the fibers and the second substrate 32 to be wound with as high a tension as desired. Winding with a high tension is desirable as high tension winding forces the adhesive to move radially out, away from the center of the mandrel, removing any small air pockets between fibers, thoroughly wetting the fibers and providing excellent sealing of the fibers by the adhesive. The final diameter of the module is controlled by the amount of the fiber, casting compound, second substrate surface 32 and tension (on the second substrate surface) used during the manufacturing process. All of these elements can be controlled. It should be pointed out that the second substrate 32 remains in the module. As a result, the second substrate plays an important role in distancing successive layers of fibers from one another.

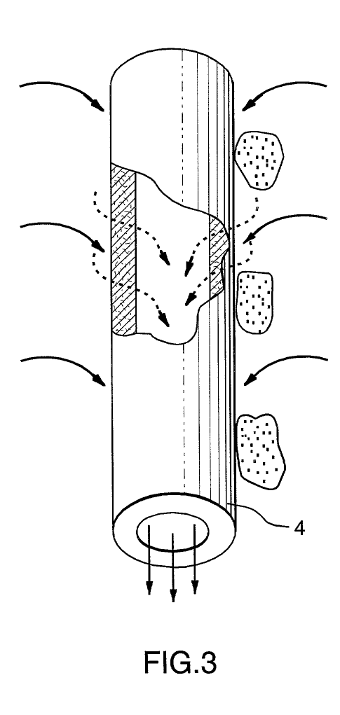

As illustrated in FIG. 4, a preferred method of constructing a hollow fiber water filter assembly comprises of the following steps:

1. transferring individual hollow fiber strands supported by a first substrate surface having a first tension level from at least one hollow fiber spool onto a second substrate surface having a second tension level,

2. monitoring the length of said first or second substrate surface;

3. controlling and applying a flow of casting adhesive onto predetermined locations on said second substrate surface so as to set a desired spacing between said individual fibers and said substrate surface,

4. winding at a high tension said cast second substrate surface and individual fibers so as to form a cast fiber roll,

5. curing said cast fiber roll,

6. cutting through said cast portions of said roll to create individual hollow fiber filter modules having a plurality of openings at a top and bottom end,

7. optionally sealing said openings at said top end, and

8. inserting, affixing and sealing said module into a housing.

At step (g), the center of the mandrel 24 is also sealed by the either casting compound or by a hot melt. Step (g) is optional because an alternative configuration that would fall into the scope of the invention, namely the inside-out configuration, is possible. In this latter configuration, after the casting compound is cut (leaving open fibers at both ends), both ends may be potted (sealed inside a larger tube). The end result is that fluid passes through the center of the fibers. This is known as the inside-out configuration.

The fiber processing operation according to the invention comprises different actions which are shown in the flow chart of FIGS. 1A and 1B. The operation comprises the following actions:

A1 Loading of hollow fiber spool in the manufacturing apparatus.

A2 Loading of the supporting substrate sheet or strips in the manufacturing apparatus.

A3 Loading of the unwinding adhesive tape in the manufacturing apparatus.

A4 Loading of the casting dispensers in the manufacturing apparatus.

A5 Loading of the hollow finish tube in the manufacturing apparatus.

B Attaching the substrate through the feed path of the manufacturing apparatus.

C Extraction of the individual hollow fiber strands.

D Regulation of the casting compound flow controller for optimum casting compound release.

E1 Placement of the fibers on the substrate sheet, or

E2 Placement of the fibers on the substrate strips.

F Application of the casting adhesive compound onto the second substrate.

G Removal of the cast fiber roll.

H Rotation of the cast fiber roll during curing of the adhesive.

I Cutting of product to specifications.

J Plugging shaft and sealing top.

K Insertion and affixing to housing.

L Quality control, for example using a particle counter.

It will be appreciated that the above description relates to the preferred embodiment by way of example only. Many variations on the invention will be obvious to those knowledgeable in the field, and such obvious variations are within the scope of the invention as described and claimed, whether or not expressly described.

For instance, although the description of the invention is directed to an outside-in flow configuration (water flowing from the outside of the fiber to the inside), there is an alternative configuration that would fall into the scope of the invention, namely the inside-out configuration. In this latter configuration, after the casting compound is cut (leaving open fibers at both ends), both ends may be potted (sealed inside a larger tube). The end result is that fluid passes through the center of the fibers. This is known as the inside-out configuration.

What is claimed as the invention is:

1. A disposable water filter assembly comprising:
a sealed housing having a water inlet positioned at a top end of the housing and a filtered water outlet positioned at a bottom end of the housing, and defining a cavity region therein to house a first filter element and a second filter element; where said second filter element is arranged in series with said first filter element, and said second filter element comprises a plurality of hollow fibers, each fiber constituting a hollow membrane, characterized by the fibers being positioned in a substantially linear and parallel fashion relative to one another, and the membrane walls being microporous, said membrane walls defining a hollow passageway for filtered water to exit therethrough; and,
a first layer of cast material bonded to first ends of the fibers so as to block fluid entry through openings of said hollow fibers at said first ends and, a second layer of cast material bonded to second ends of the hollow fibers so as to expose the openings of said hollow fibers at said second ends for filtered water exit, said first and second layers being co-axially spaced apart so as to be relatively parallel and linear to one another.

2. A filter system as claimed in claim 1, wherein the second filter element is disposed upstream from the first filter element.

3. A filter system as claimed in claim 1, wherein the second filter element is disposed downstream from the first filter element.

4. A filter system as claimed in claim 1, wherein the membrane walls of the hollow fibers have a pore size in the range of 0.001 through to 0.04 microns and thereby block at least cryptosporidium, giardia, bacteria, sediment and organic products.

5. A filter system as claimed in claim 4, wherein the system further includes a water vessel having a base to releaseably receive the filter housing therein.

6. A filter system in as claimed in claim 5, wherein the housing includes a one-way air valve to allow air to escape.

7. A filter system as claimed in claim 6, wherein a third filter element is arranged in series with and between the first filter element and the second filter element.

8. A filter system as claimed in claim 7, wherein said first filter element comprises a carbon bed filter.

9. A method of constructing a hollow fiber water filter assembly, said method comprising the steps of:
a. transferring individual hollow fiber strands supported by a first substrate surface having a first tension level from at least one hollow fiber spool onto a second substrate surface having a second tension level;
b. monitoring the length of said first or second substrate surface;
c. controlling and applying a flow of casting adhesive through casting adhesive dispensers onto predetermined locations on said second substrate surface so as to set a desired spacing between said individual fibers and said substrate surface;
d. winding at a high tension said cast second substrate surface and individual fibers so as to form a cast fiber roll;
e. curing said cast fiber roll;
f. cutting through the cast portions of said cast fiber roll to create individual hollow fiber filter modules having a plurality of openings at a top end and a bottom end; and
g. inserting, affixing and sealing said module into a housing.

10. A method of constructing a filter assembly as claimed in claim 9, wherein before step (g) there includes the step of sealing said openings at said top end.

11. A method of constructing a filter assembly as claimed in claim 10, wherein before step (a) there includes a step of loading individual strands of hollow fiber onto at least one spool, said strands resting in a parallel fashion to an axis of said spool.

12. A method of constructing a filter assembly as claimed in claim 11, wherein the step of transferring individual strands is achieved by having said an outside layer of strands on said spool make contact with an unwinding adhesive surface.

13. A method of constructing a filter assembly as claimed in claim 12, wherein the curing of step (e) further comprises removing said cast fiber roll from a spindle and rotating said fibers to evenly cure the cast fiber roll.

14. A method of constructing a filter assembly as claimed in claim 13, further including a step of inserting and affixing a filtering media upstream or downstream from said module prior to sealing said module in said housing.

15. A method of constructing a filter assembly as claimed in claim 14, wherein the substrate surface of said step (c) are sheets and wherein the casting of step (d) is applied in straight beads to preset spacing.

16. A method of constructing a filter assembly as claimed in claim 14, wherein the substrate surface of said step (c) are strips and wherein the casting of step (d) is applied onto the strips.
